(19) United States
(12) Patent Application Publication
(10) Pub. No.: US 2009/0196451 A1
(43) Pub. Date: Aug. 6, 2009

(54) DYNAMIC MICROPHONE SUPPORT APPARATUS

(76) Inventor: Paula Abdul, Los Angeles, CA (US)

Correspondence Address: PATENT INGENUITY, PC, 520 BROADWAY, SUITE 350, SANTA MONICA, CA, 90401, US

(21) Appl. No.: 12/024,976

(22) Filed: Feb. 1, 2008

(51) Int. Cl. H04R 1/02

(52) U.S. Cl. 381/363

(57) ABSTRACT

An apparatus has a base that has a concave-shaped bottom portion that is positional on a surface. Further, the apparatus has a compartment in the base that stores an adhesive material. In addition, the apparatus has a base cover that is positioned over the base and covers the compartment such that weight of a user positioned on the base cover applied in a direction causes the base to tilt with respect to the surface in the direction. The apparatus has a rod member having a first end, a second end, and a middle portion. The first end is positioned through an opening in the base cover into the adhesive material in the compartment such that the rod member is immovable with respect to the base. The second end is configured to receive a microphone apparatus. The middle portion is configured to connect the first end and the second end.

### BACKGROUND

1. Field

This disclosure generally relates to the field of support structures. More particularly, the disclosure relates to an apparatus that supports a microphone.

2. General Background

A microphone is typically supported by a static microphone support apparatus. In other words, a user of the microphone normally places the microphone on a stand that is statically positioned in a single location. When the user would like to talk or sing into the microphone, the user generally has to approach the microphone stand. The user can then talk or sing directly into the microphone, but with a limited amount of movement so that the user stays within close proximity to the microphone. The microphone is typically too heavy and cumbersome to be picked up and moved around with the microphone.

During a performance, the quality of the audio that is outputted form the microphone is normally affected by the performer moving with respect to the stationary microphone. Even when moving within close proximity to the microphone, the performer still has to move his or her head with respect to the microphone. Such movement may lead to inconsistent quality in the audio that is outputted from the microphone.

The only current alternative for a user that would like unrestricted movement is to remove the microphone from the stand and move about with the microphone. Such an alternative may present a number of safety hazards. For example, if the microphone is connected via cable, the user may trip over the cable while moving about with the microphone. A performer on stage at a concert may have a dance routine in addition to a singing routine, and the presence of the cable may lead to the performer being tangled by the cable and tripping during the performance.

Although some microphones are wireless, the stand by itself occupies a portion of the stage and can present an additional safety hazard while the performer is performing a dance routine. This problem becomes even more significant when there are multiple performers that each have stands which are left unattended.

### SUMMARY

In one aspect of the disclosure, an apparatus is provided. The apparatus has a base that has a concave-shaped bottom portion that is positional on a surface. Further, the apparatus has a compartment in the base that stores an adhesive material. In addition, the apparatus has a base cover that is positioned over the base and covers the compartment such that weight of a user positioned on the base cover applied in a direction causes the base to tilt with respect to the surface in the direction. The apparatus also has a rod member having a first end, a second end, and a middle portion. The first end is positioned through an opening in the base cover into the adhesive material in the compartment such that the rod member is immovable with respect to the base. Further, the second end is configured to receive a microphone apparatus. In addition, the middle portion is configured to connect the first end and the second end.

In another aspect of the disclosure, an apparatus is provided. The apparatus has a base having a concave-shaped bottom portion that is positional on a surface. Further, the apparatus has a compartment in the base that stores an adhesive material. In addition, the apparatus has a base cover that is positioned over the base and covers the compartment such that weight of a user positioned on the base cover applied in a direction causes the base to tilt with respect to the surface in the direction. The apparatus also has a rod member that has a first end, a second end, and a middle portion. The first end is positioned through an opening in the base cover into the adhesive material in the compartment such that the rod member is immovable with respect to the base. Further, the second end is configured to receive a microphone apparatus. In addition, the middle portion is configured to connect the first end and the second end such that a force applied to the rod member in a direction by a user positioned on the base cover causes the base to tilt with respect to the surface in the direction.

In yet another aspect of the disclosure, an apparatus is provided. The apparatus has a base having a concave-shaped bottom portion that is positional on a surface. Further, the apparatus has a compartment in the base that stores a compound to stabilize the weight of a user. In addition, the apparatus has a base cover that is positioned over the base. The apparatus also has a rod member having a first end, a second end, and a middle portion. The first end is connected to the base cover such that the rod member is immovable with respect to the base. Further, the second end is configured to receive a microphone apparatus. In addition, the middle portion is configured to connect the first end and the second end such that a force applied to the rod member in a direction by the user positioned on the base cover causes the compound to shift in the direction, which causes the base to tilt with respect to the surface in the direction.

In another aspect of the disclosure, a kit is provided. The kit includes a microphone stand apparatus. The microphone stand apparatus has (i) a base having a concave-shaped bottom portion that is positional on a surface, (ii) a compartment in the base that stores a compound to stabilize the weight of a user, (iii) a base cover that is positioned over the base, and (iv) a rod member having a first end, a second end, and a middle portion, the first end being connected to the base cover such that the rod member is immovable with respect to the base, the second end is configured to receive a microphone apparatus, and the middle portion is configured to connect the first end and the second end such that a force applied to the rod member in a direction by the user positioned on the base cover causes the compound to shift in the direction, which causes the base to tilt with respect to the surface in the direction. The kit also includes a microphone that is operably connected to the second end.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIGS. 1A and 1B illustrate implementations of a dynamic microphone support apparatus.

FIG. 1A illustrates the dynamic microphone support apparatus that may be utilized in conjunction with a microphone, a microphone receptacle, and a microphone connector.

FIG. 1B illustrates the dynamic microphone support apparatus that may be utilized in conjunction with a microphone and a microphone receptacle without the microphone connector shown in FIG. 1A.

FIG. 2 illustrates an assembly of the support apparatus from FIG. 1A connected to the microphone connector, the microphone receptacle, and the microphone.

FIGS. 3A-3C illustrate the assembly shown in FIG. 2 as utilized by a performer 302.

FIG. 3A illustrates the performer standing on the base cover in a neutral balanced position.

FIG. 3B illustrates a leftward tilt from the perspective of the performer.

FIG. 3C illustrates a rightward tilt from the perspective of the performer.

FIGS. 4A-4D illustrate various configurations for operably connecting the rod member to the base cover.

FIG. 4A illustrates an internal view of the assembly shown in FIG. 2.

FIG. 4B illustrates an internal view of an alternative embodiment of the assembly shown in FIG. 2.

FIG. 4C illustrates an internal view of another alternative embodiment of the assembly shown in FIG. 2.

FIG. 4D illustrates an internal view of yet another alternative embodiment of the assembly shown in FIG. 4C.

FIGS. 5A-5D illustrate various configurations for operably connecting the base cover to the base.

In particular, FIG. 5A illustrates the base cover having a downwardly extending recessed portion, which may be threaded.

FIG. 5B illustrates the base cover having a downwardly extending portion, which may be threaded.

FIG. 5C illustrates the base cover having a plurality of holes and the base having an inner wall portion with corresponding holes.

FIG. 5D illustrates the base cover having a plurality of holes and the top of the base having corresponding holes.

FIGS. 6A and 6B illustrate alternative configurations for filling and removing the compound from the compartment in the base.

FIG. 6A illustrates an opening in the base cover in which the compound may be placed within the compartment or removed from the compartment of the base.

FIG. 6B illustrates an opening in the base in which the compound may be placed within the compartment or removed from the compartment of the base.

### DETAILED DESCRIPTION

A dynamic microphone support apparatus is provided. The dynamic microphone support apparatus allows a user to move a microphone support, e.g., a microphone stand, in conjunction with talking or singing into a microphone. Further, the microphone stand can be moved seamlessly in a fashion that is not difficult for a large number of users of varying ages and physical strengths. In addition, the dynamic microphone support apparatus eliminates the safety hazards that are seen with a static microphone support apparatus.

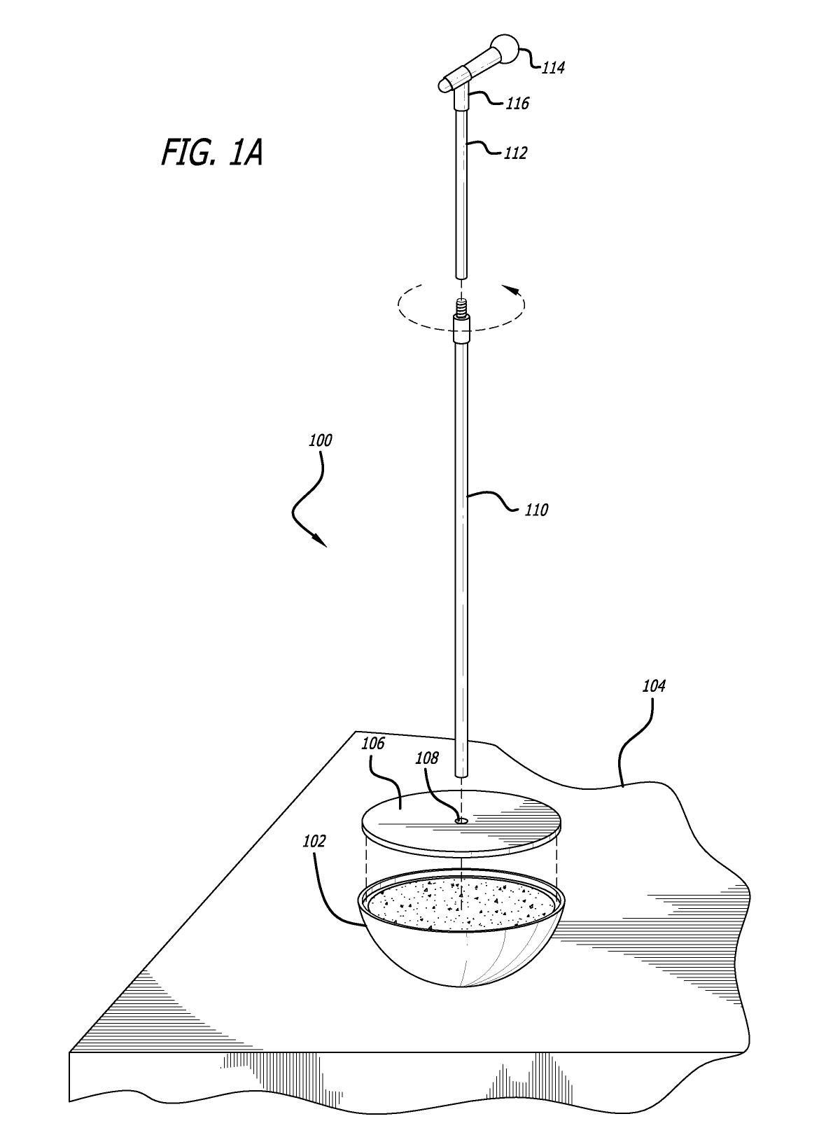

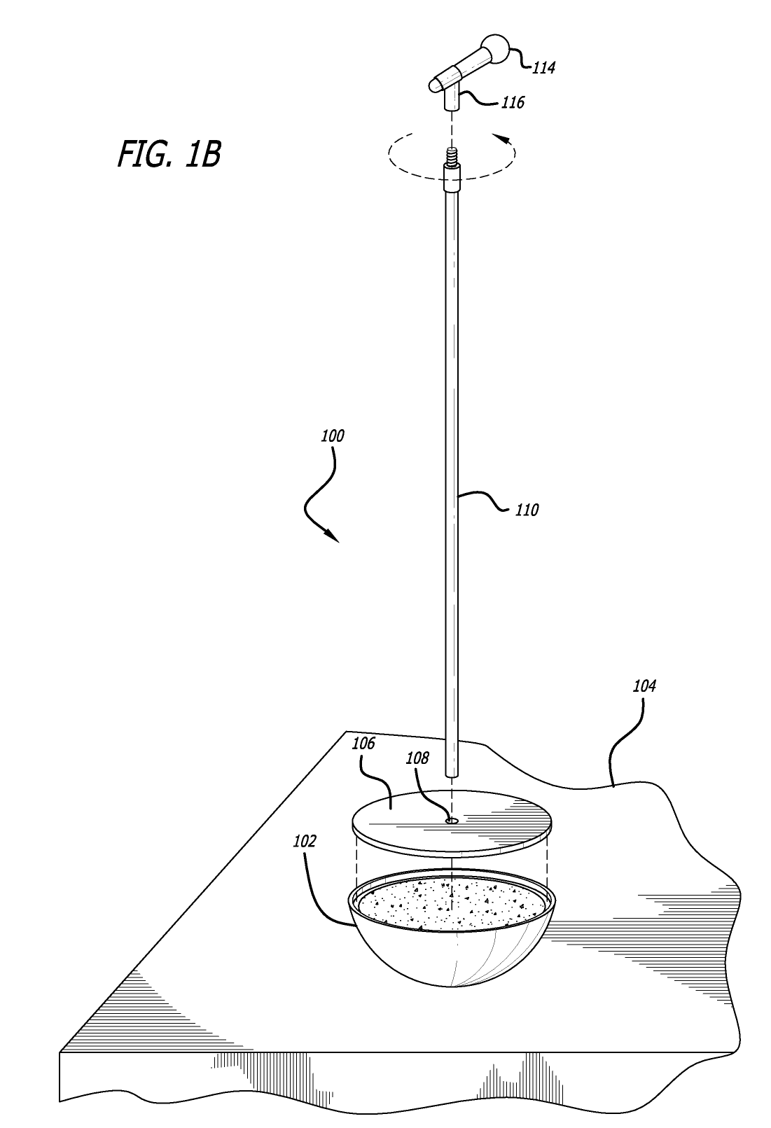

FIGS. 1A and 1B illustrate implementations of a dynamic microphone support apparatus 100. In particular, FIG. 1A illustrates the dynamic microphone support apparatus 100 that may be utilized in conjunction with a microphone 114, a microphone receptacle 116, and a microphone connector 112. The dynamic microphone support apparatus 100 includes a base 102 that has a concave-shaped bottom portion. In one embodiment, the bottom portion is entirely concave. In another embodiment, the bottom portion may be partially concave such that another part of the bottom portion is flat. For example, the bottom portion may have a flat portion that then concaves upward so that there is extra stability.

Further, in one embodiment, the concave-shaped bottom portion curves upward to the top portion of the base so that the base 102 is entirely concave. In another embodiment, the concave-shaped bottom portion curves upward to a certain point where the base 102 then extends vertically upward. Accordingly, the base 102 having the concave-shaped bottom portion does not necessitate a concave shape for the entirety of the base 102.

The concave-shaped bottom portion of the base 102 may be positioned on a surface 104. For example, the concave-shaped bottom portion may be positioned on a stage where a performer intends to sing or speak with the microphone 114.

The base 102 also has a compartment that stores a compound. An example of the compound is an adhesive material such as cement or glue. Various other compounds such as water, sand, etc., may be utilized.

A base cover 106 is operably connected to the base 102 to cover the compartment. The base cover 106 is made from a material and is of a thickness that make the base cover 106 durable enough to withstand a large downward force. For example, when the base cover 106 is operably connected to the base 102, an adult is be able to stand on top of the cover 106 without the base cover 106 collapsing, bending, etc. The base cover 106 remains intact before, during, and after an adult stands on top of the cover 106. Accordingly, the base cover 106 is intended to withstand a load exerted on it from a single individual that may be a child or adult of varying sizes and weights. In alternative embodiment, the circumference of the base 102 and the circumference base cover 106 is substantially increased from that illustrated in FIG. 1A to withstand the load of multiple users at one time.

When a user stands in a balanced position on the assembled base 102 and base cover 106, the assembled base 102 and base cover 106 remain stationary. In one embodiment, the angle of the curve towards the bottom of the concave-shaped bottom portion of the base 102 is sufficiently less than the angle of the curve towards the top of the base 102 to distribute the weight of the user effectively. As an example, the angle of the bottom of the concave-shaped bottom portion of the base 102 relative to the surface 104 may begin at an angle of zero degrees and slightly increase to an angle in the range of one degree to fifteen degrees along the bottom of the concave-shaped bottom portion of the base 102. As the curve approaches the top portion of the base 102, the angle may begin at an angle in the range of sixty degrees to eighty five degrees and then end at an angle of ninety degrees. These ranges are provided merely as examples. One of ordinary skill in the art will recognize that angles slightly outside of these ranges may also be sufficient for effective weight distribution.

If a user shifts his or her weight in a particular direction, the assembled base 102 and base cover 106 tilt in that direction. In one embodiment, the concave shape of the bottom portion of the base allows for the assembled base 102 and base cover 106 to tilt in the direction. For example, if a user places his or her feet on the base cover 106 and applies equal pressure with both feet, the assembled base 102 and base cover 106 remain stationary. However, if the user applies more pressure with his or her right foot than left foot, the assembled base 102 and base cover 106 tilt towards the right. Conversely, if the user applies more pressure with his or her left foot than right foot, the assembled base 102 and base cover 106 tilt towards the left.

In one embodiment, the range of movement of the assembled base 102 and base cover 106 is restricted so that the angle of the tilt is not too large to allow the assembled base 102 and base cover 106 to topple over. The restricted range of movement is helpful in providing safety to a user of the dynamic microphone support apparatus 100. In one embodiment, the angle of the curve towards the bottom of the concave-shaped bottom portion of the base 102 is sufficiently less than the angle of the curve towards the top of the base 102. Similar ranges may be utilized as discussed with respect to providing effective weight distribution for the user. As a result, the angles of the curve in the concave shape are helpful in both effectively distributing the weight of the user and restricting the tilt of the assembled base 102 and base cover 106.

In an alternative embodiment, the compartment may be narrowed so that the compartment does not occupy the periphery of the base 102. For example, a space may exist between the compartment and the periphery of the inner layer of the base 102. This space may be large enough to allow the weight of the compound in the compartment to be directed towards the portion in the center of the base 102. As a result, the user standing in a neutral position on the base cover 106 may stay in that neutral position. If the user moves in a particular direction, the assembled base 102 and base cover 106 may tilt in that direction, but will have a restricted range of motion based on the weight of the compound being directed towards the center of the base 102.

In yet another alternative embodiment, the compartment is not narrowed, but a variation in the amount of the compound is utilized for effective weight distribution and restriction of tilt movement. For example, a large amount of cement may be utilized towards the center of the base 102, e.g., filling the base 102 to the top with cement in the center and the immediately surrounding area, and a small amount of cement may be utilized towards the periphery of the base 102, e.g., filling the base 102 only halfway with cement in the area around the periphery of the base 102. Alternatively, the compartment may be shaped so that it is large towards the center to store more of the compound and is smaller towards the periphery to store less of the compound.

In another alternative embodiment, a mixture of compounds with varying densities is utilized for effective weight distribution and restriction of tilt movement. In other words, a first compound may be utilized towards the center whereas a second compound with a lower density may be utilized towards the periphery of the base 102.

While these approaches may be utilized independently to provide effective weight distribution and restriction of tilt movement, a combination of some or all of these approaches may also be utilized. For example, the angles may be configured in conjunction with a narrower compartment to sufficiently provide effective weight distribution and restriction of tilt movement. Such a combination may be utilized to reduce the emphasis on any one of these individual approaches. For example, the combination of angles and a narrower compartment may allow for larger angles and a less narrow compartment than if these approaches were independently utilized.

In one embodiment, once the tilt is restricted by an approach or combination of approaches discussed above, the user is in a stationary position at that tilt. For example, if the user applies more pressure with his or her right foot than left foot, the assembled base 102 and base cover 106 tilt towards the right and remain in that position until the user shifts direction again. The user may apply just enough pressure to the left to move back to the neutral balanced position or may apply more pressure to move all the way to the left. Alternatively, the user in the rightward tilted position may apply pressure to tilt forward so that the user is in a rightward forward tilted position or backward so that the user is in a rightward backward tilted position. The examples provided above are intended only for illustrative purposes as various positions may be reached as a result of the tilting motion. For example, the user may provide pressure along a forward diagonal rightward so that the assembled based 102 and base cover 106 are tilted forward and to the right on a diagonal.

In another embodiment, once the tilt is restricted by an approach or combination of approaches discussed above, the dynamic microphone support apparatus 100 automatically tilts back to the neutral balanced position. This may be accomplished with a relatively small angle along the concave-shaped bottom portion of the base 102 and/or the weight of the compound being sufficiently directed towards the center of the base 102. For example, if the user applies more pressure with his or her right foot than left foot, the assembled base 102 and base cover 106 tilt towards the right up until the restricted range of motion, and then the assembled base 102 and base cover 106 automatically move back to and possibly through (depending on the amount of pressure) the neutral balanced position. The user can then move again in the same or a different direction, and the assembled base 102 and base cover 106 will once again automatically move back to or through the neutral balanced position.

The determination as to whether the dynamic microphone support apparatus 100 stays in a tilted position or automatically moves back to or through the neutral balanced position depends on factors such as the angle of the curve along the concave-shaped bottom portion of the base 102 and the weight of the compound directed towards the center of the base 102. A larger angle and more evenly distributed weight of the compound throughout the base 102 helps the dynamic microphone support apparatus 100 stay in the tilted position whereas a smaller angle and distribution of the weight of the compound towards the center of the base 102 helps the dynamic microphone support apparatus 100 automatically tilt back to the neutral balanced position.

The base cover 106 also provides a buffer between the user and the compound stored in the compartment. For example, the user would likely feel more comfortable standing on a smooth durable surface rather than glue, cement, etc. The base cover 106 may be made from a metal, plastic, or any other material that provides sufficient durability to withstand the load from the weight of the user.

The dynamic microphone support apparatus 100 also has a rod member 110, which is operably connected to the base cover 106. The rod member 110 has a first end, a second end, and a middle portion. As illustrated in FIG. 1A, the first end is positioned through an opening 108 in the base cover 106. As an example, the compound in the compartment of the base 102 may be an adhesive material such as cement into which the first end of the rod member 110 is inserted prior to drying of the cement. After drying of the cement, the rod member is now effectively connected to the base 102. The rod member 110 is immovable with respect to the base such that a movement of the rod member 110 would also lead a movement of the base 102 such as a tilt. The rod member 110 is made from a material and is of a thickness such that a user's exertion of pressure on the rod member 110 does not normally cause the rod member 110 to break. Accordingly, the rod member 110 can be made from most metals, plastics, or other suitable materials. In one embodiment, the base 102 is filled with the cement, the base cover 106 is operably connected to the base 102, and the first end of the rod member 110 is inserted into the cement through the opening 108. In another embodiment, the base 102 is filled with the cement, the first end of the rod member 110 is inserted into the cement, and the opening 108 is large enough so that the based cover can be placed over the second end of the rod member and slid down the middle portion to then be operably connected to the base 102.

As discussed above, the base 102 may tilt in response to an imbalanced use of pressure by the feet of the user. Similarly, the user may keep the pressure from his or her feet balanced, but may exert a force on the rod member 110 that causes the base 102 to tilt. For example, if the user exerts a sufficient rightward force with his or her hands on the rod member 110 to move the rod member 110 rightward, the base 102, which is immovable with respect to the rod member 110, has to tilt rightward. The approaches discussed above regarding the angles and weight distribution of the compound for allowing a tilted position to be stationary or an automatic move back from the tilted position are also applicable with respect the tilt being caused by a force exerted by the hands of the user on the rod member 110.

Further, the tilt may be caused by a combination of forces exerted on the rod member 110 and the base cover 106. For example, the user may be able to make a faster movement rightward if he or she exerts a force rightward on the rod member 110 in addition to, at the same time, providing more pressure with his or her right foot than left foot on the base cover 106.

Further, the second end of the rod member 110 is configured to receive a microphone apparatus. The microphone apparatus may include a microphone 114, a microphone receptacle 116 into which the microphone may be placed, and a microphone connector 112 that matingly engages with the second end of the rod member 110. The term matingly engage is intended to include any effective fastening methodology. As illustrated in FIG. 1A, the second end of the rod member 110 may have threads so that the microphone connector 112 may be screwed onto it. However, other fastening methodologies may be utilized.

Further, FIG. 1B illustrates the dynamic microphone support apparatus 100 that may be utilized in conjunction with a microphone 114 and a microphone receptacle 116 without the microphone connector 112 shown in FIG. 1A. Accordingly, in an alternative embodiment, the receptacle 116 is directly matingly engaged with the rod member 110. The rod member 110 may be made longer for this particular embodiment to compensate for the lack of the microphone connector 112. However, the rod member 110 in either embodiment may include multiple members connected to one another and slidable with respect to one another so that the rod member 110 is adjustable in height for users having different heights. Alternatively, the microphone connector 112 may include multiple members connected to one another and slidable with respect to one another to provide the user with the convenience of adjusting the microphone height at a higher level.

In yet another embodiment, the microphone 114 may be directly connected to the rod member 110. As an example, the microphone 114 may have a threaded bottom to matingly engage with the rod member 110. The microphone 114 may then be vertically positioned on the rod member 110. The microphone 114 may also have a threaded portion in the middle of the microphone 114 to allow the microphone to be horizontally twisted onto the rod member 110.

Although the threads in FIGS. 1A and 1B are illustrated as protruding from the rod member 110, the threads may alternatively protrude from the microphone connector 112, the microphone receptacle 116, or the microphone 114 depending on which configuration is utilized. Accordingly, the rod member may have a receptacle with inner threads for receiving any of these components. These fastening methodologies are intended only as examples as a variety of fastening methodologies may be utilized.

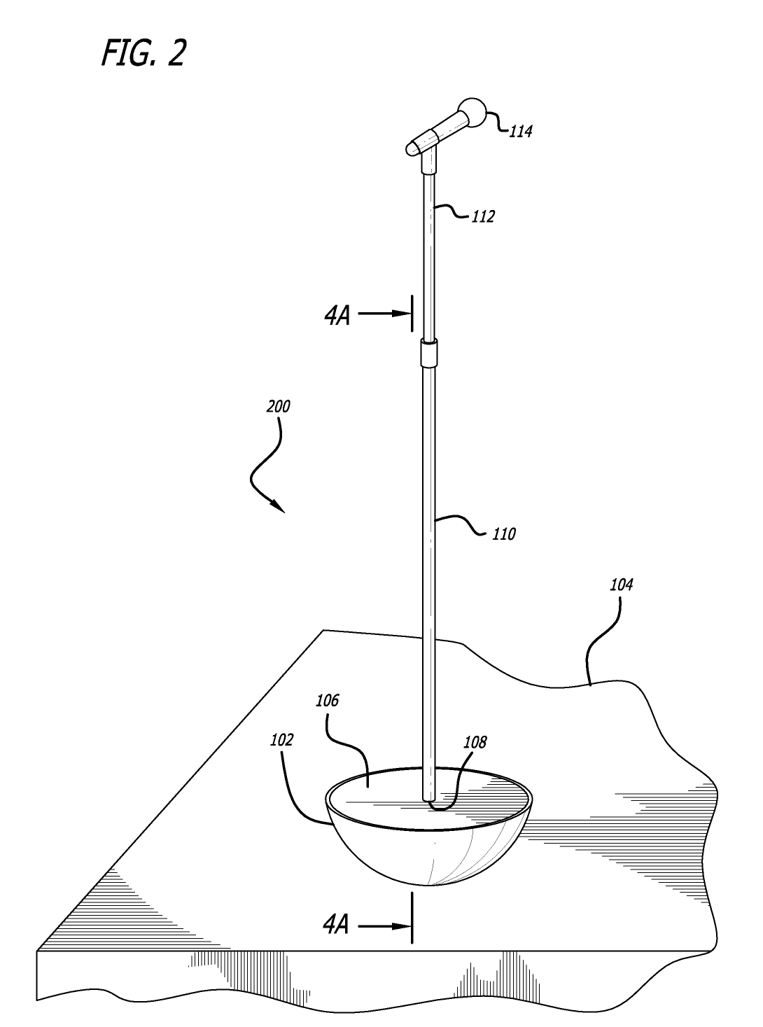

FIG. 2 illustrates an assembly 200 of the dynamic microphone support apparatus 100 from FIG. 1A connected to the microphone connector 112, the microphone receptacle 116, and the microphone 114. The assembly 200 may be positioned on a surface 104 such as a stage for a performance. The assembly 200 may be utilized by users in homes or other areas to perform on their own, or even sing along with their favorite performers while watching performance on the television or listing to performances on the radio.

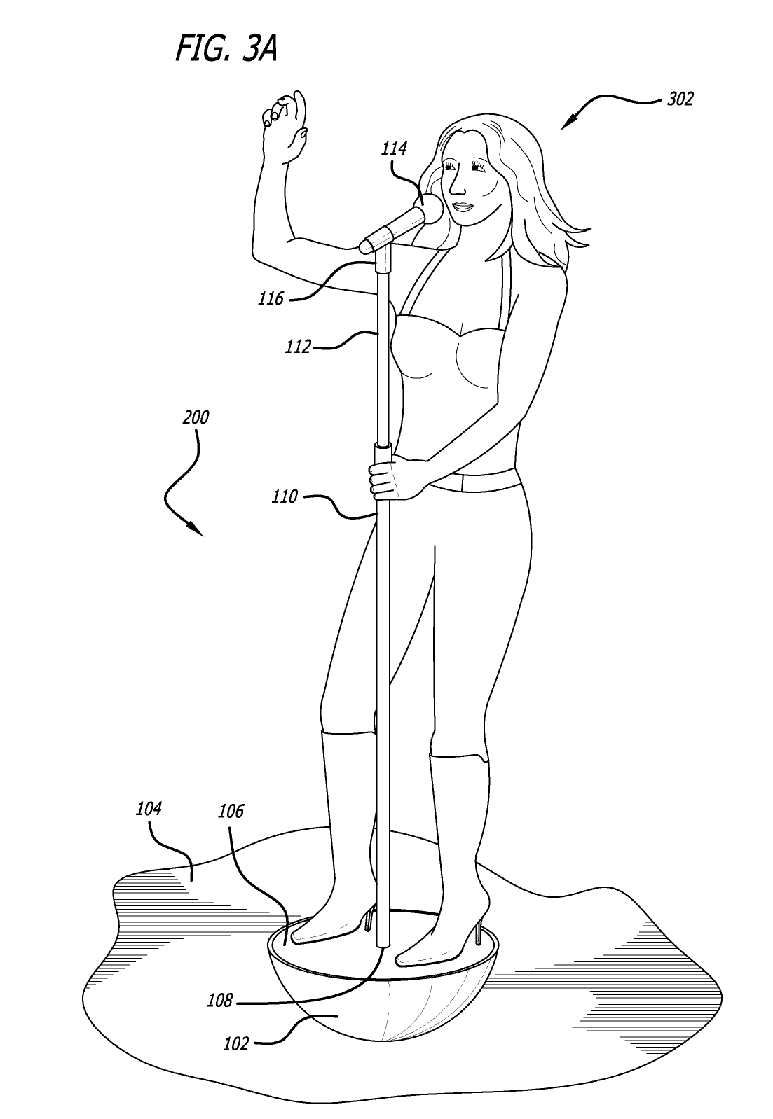

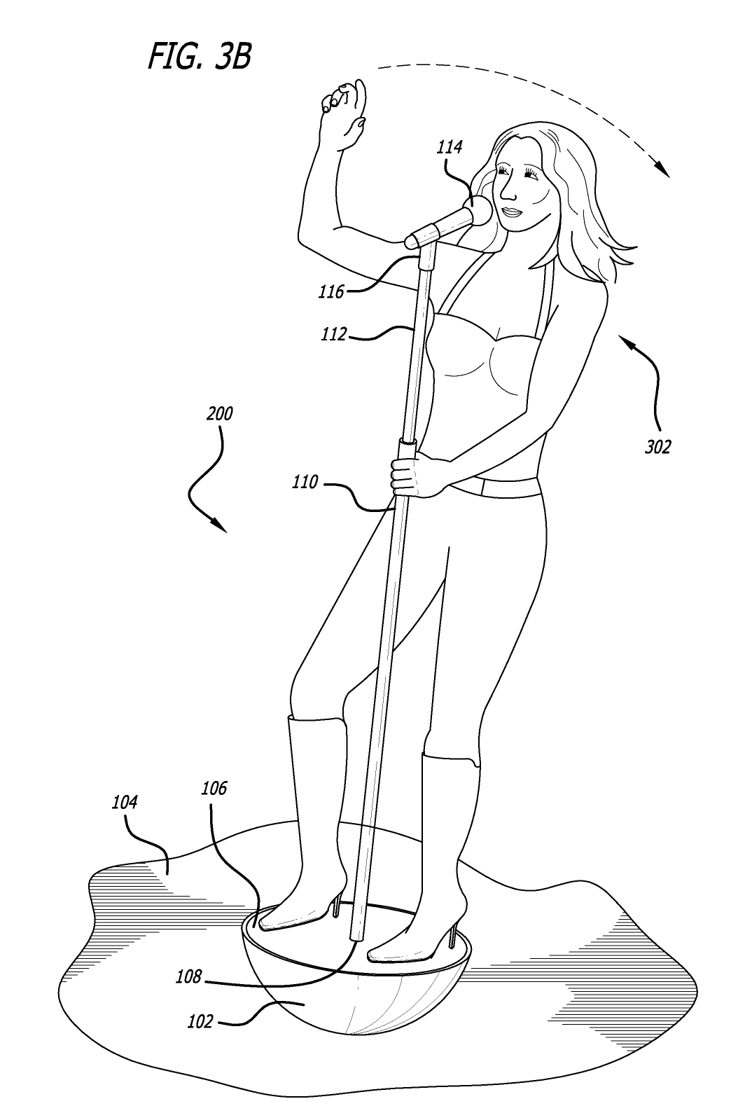

FIGS. 3A-3C illustrate the assembly shown in FIG. 2 as utilized by a performer 302. In particular, FIG. 3A illustrates a performer 302 standing on the base cover 106 in a neutral balanced position. The performer 302 is applying equal pressure with both of her feet onto the base cover 106 and is not exerting any substantial force on the rod member 110.

FIG. 3B illustrates a leftward tilt from the perspective of the performer 302. The leftward tilt is caused by the performer 302 exerting more pressure on her left foot than her right foot and/or the performer 302 exerting a leftward directed force on the rod member 110. As a result, the base 102 and the base cover 106 tilt to the left, which causes the performer to also tilt to the left. The force may optionally be exerted on the microphone connector 112, which is operably connected to the rod member 110.

In addition, FIG. 3C illustrates a rightward tilt from the perspective of the performer 302. The rightward tilt is caused by the performer 302 exerting more pressure on her right foot than her left foot and/or the performer 302 exerting a rightward directed force on the rod member 110. As a result, the base 102 and the base cover 106 tilt to the right, which causes the performer to also tilt to the right.

As can be seen from FIGS. 3A-3C, the performer 302 may move during a performance and basically have the microphone follow her movements. As a result, her head does not move too much with respect to the microphone 114 and allows for consistency in the quality of the audio outputted from the microphone 114. Further, the safety concerns of stationary microphone stands during a dance performance are alleviated as the dynamic microphone support apparatus 100 follows the performer 302.

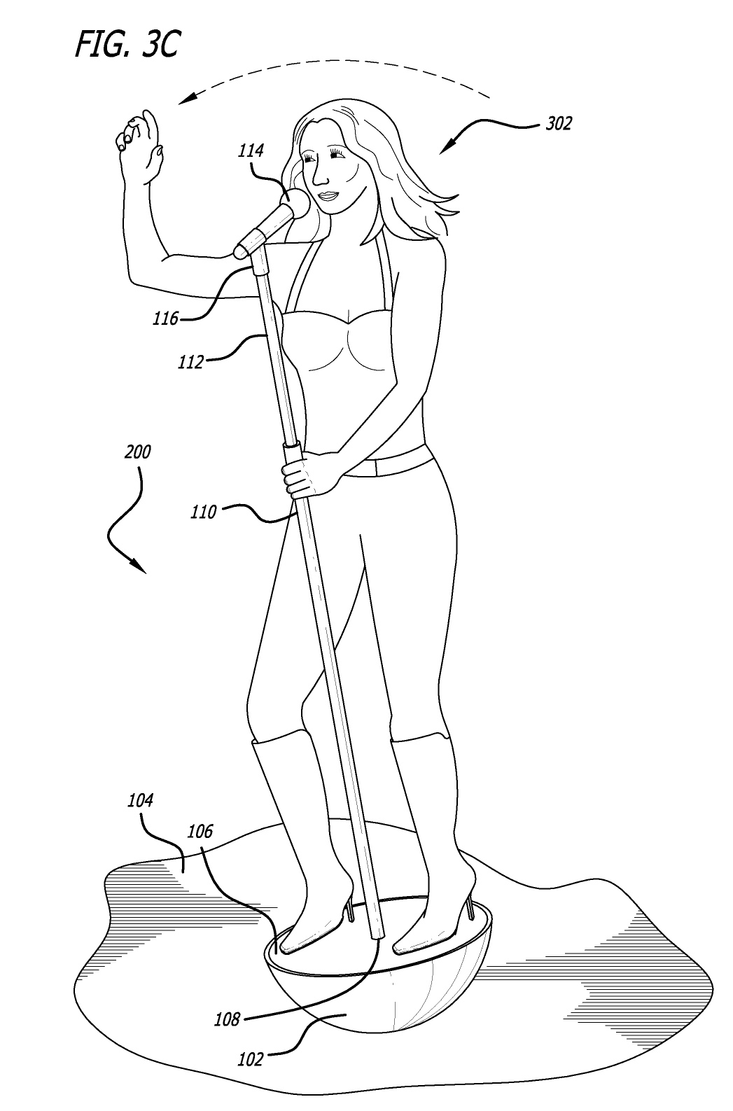

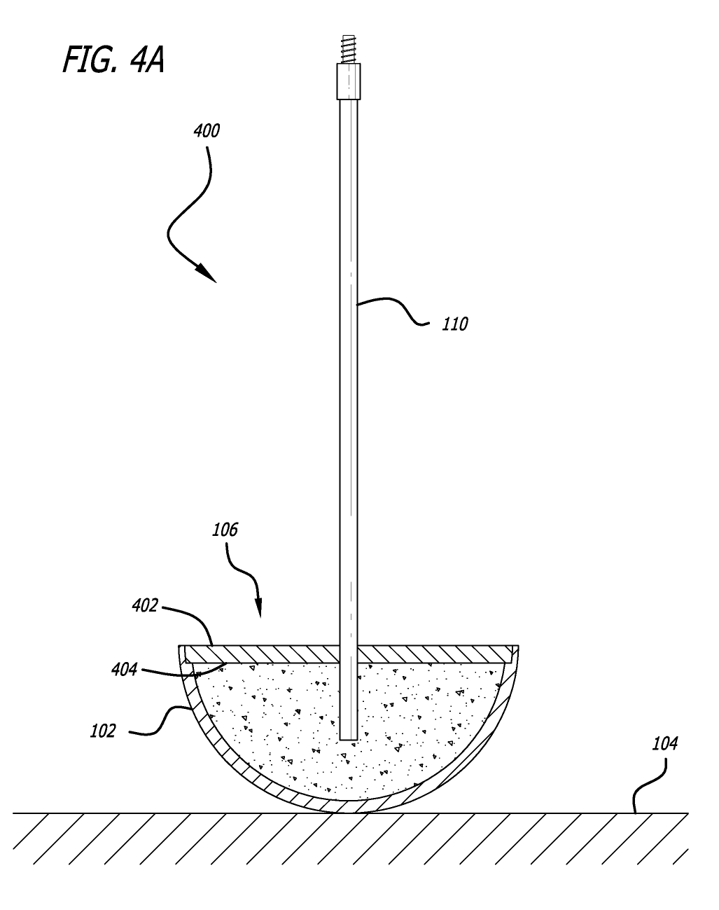

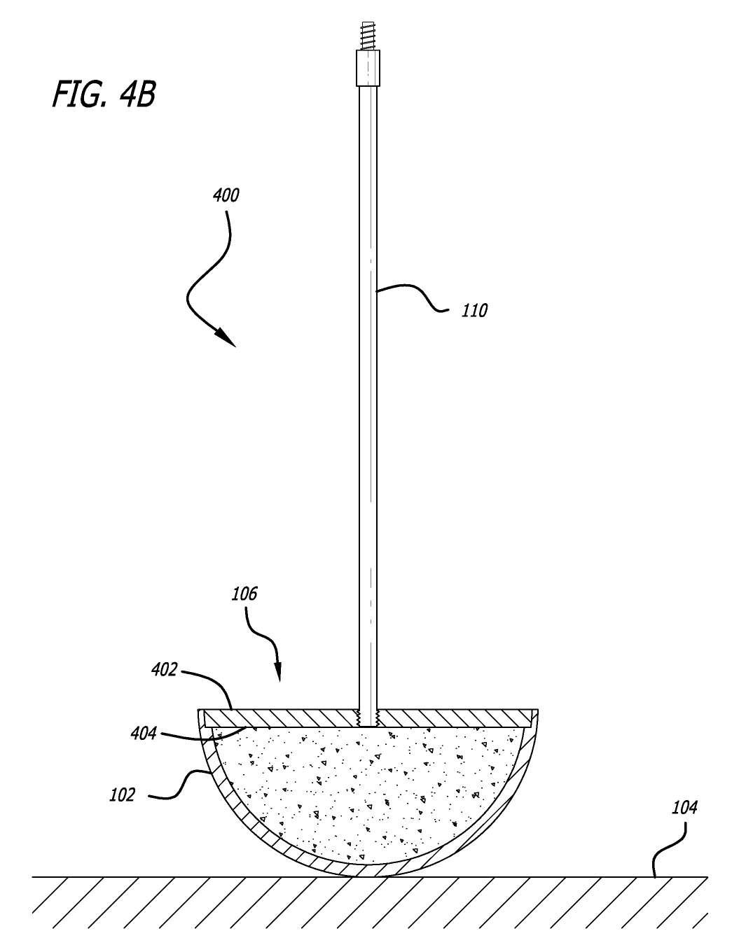

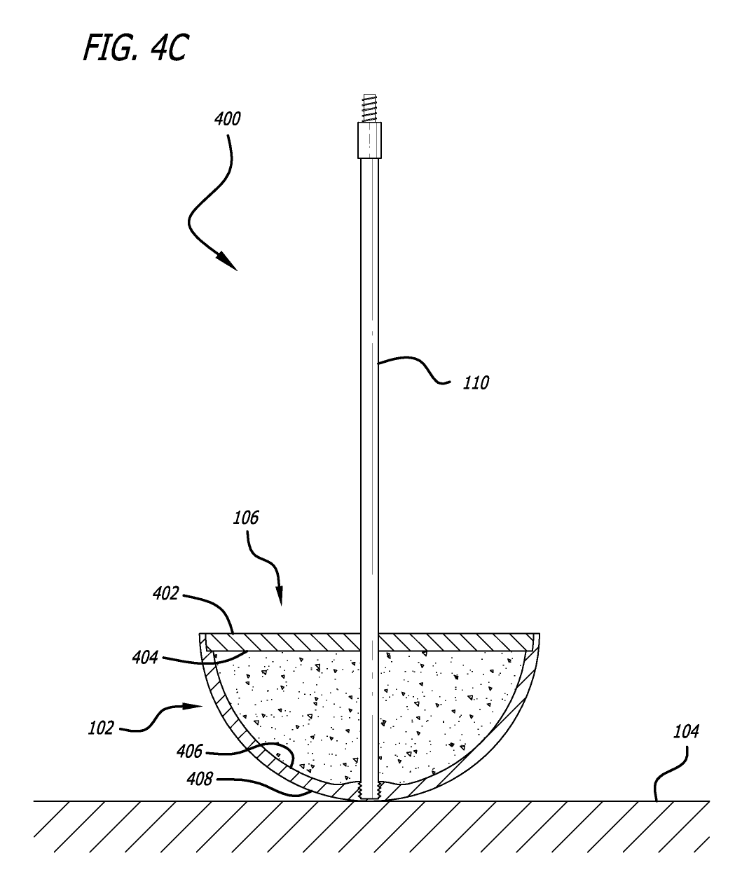

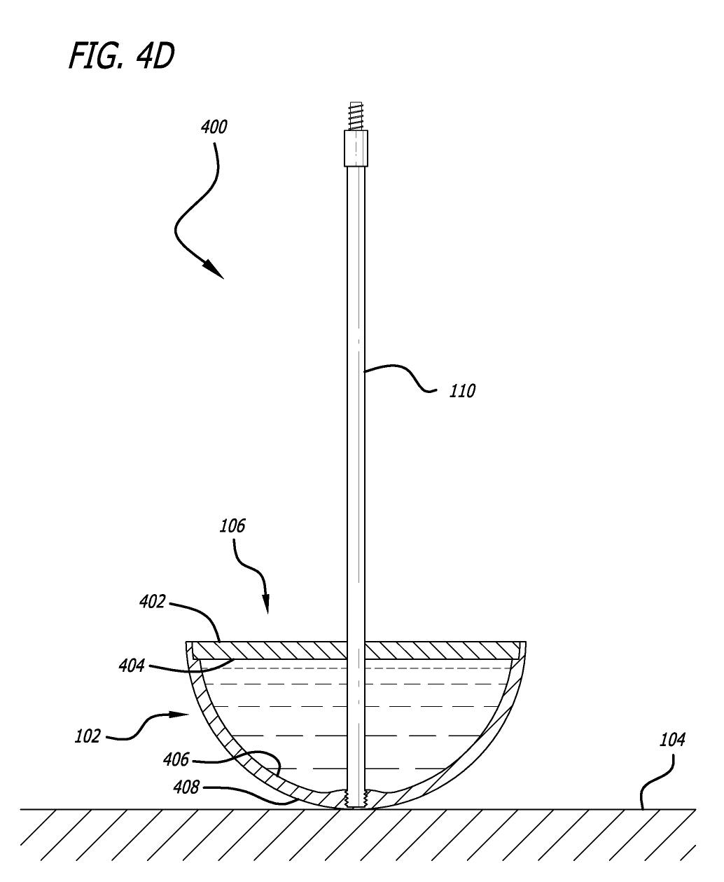

FIGS. 4A-4D illustrate various configurations for operably connecting the rod member 110 to the base cover 106. FIG. 4A illustrates an internal view of the assembly 200 shown in FIG. 2. The opening 108 allows the rod member 110 to extend directly down into the compartment of the base 102. As the compartment in this embodiment contains cement, the rod member only needs to be inserted a sufficient amount into the cement to solidify the connection rather than to the bottom of the base 102. For example, the rod member 110 may be inserted halfway into the compartment of the base 102. The rod member 110 may be inserted all the way to the bottom in this embodiment, but it is not necessary.

FIG. 4B illustrates an internal view of an alternative embodiment of the assembly 200 shown in FIG. 2. In this embodiment, the compound may be an adhesive or a non-adhesive material. For example, sand may be utilized. The rod member 110 extends through the opening 108 in an outer layer 402 of the base cover 106 and stops at an inner layer 404 of the base cover 106. The hole created by the opening 108 may have threads to allow the rod member 110 to be matingly engaged to the base cover 106. However, other fastening methodologies, e.g., utilizing glue, may operably connect the rod member 110 to the base cover 106.

FIG. 4C illustrates an internal view of an alternative embodiment of the assembly 200 shown in FIG. 2. In this embodiment, the compound may be an adhesive or a non-adhesive material. For example, sand may be utilized. The rod member 110 extends through the opening 108 in the outer layer 402 of the base cover 106 through the inner layer 404 of the base cover 106 into the compartment. The rod member 110 then extends into the compartment down through an opening in an inner layer 406 of the concave-shaped bottom portion down to an outer layer 408 of the concave-shaped bottom portion. The hole created by the opening in the inner layer 406 of the concave-shaped bottom portion may have threads to allow the rod member 110 to be operably connected to the base cover 106 by being matingly engaged to the concave-shaped bottom portion. However, other fastening methodologies, e.g., utilizing glue, may operably connect the rod member 110 to the opening created by the inner layer 406 of the concave-shaped bottom portion.

FIG. 4D illustrates an internal view of an alternative embodiment of the assembly 200 shown in FIG. 4C. In this embodiment, the compound may be a fluid such as water.

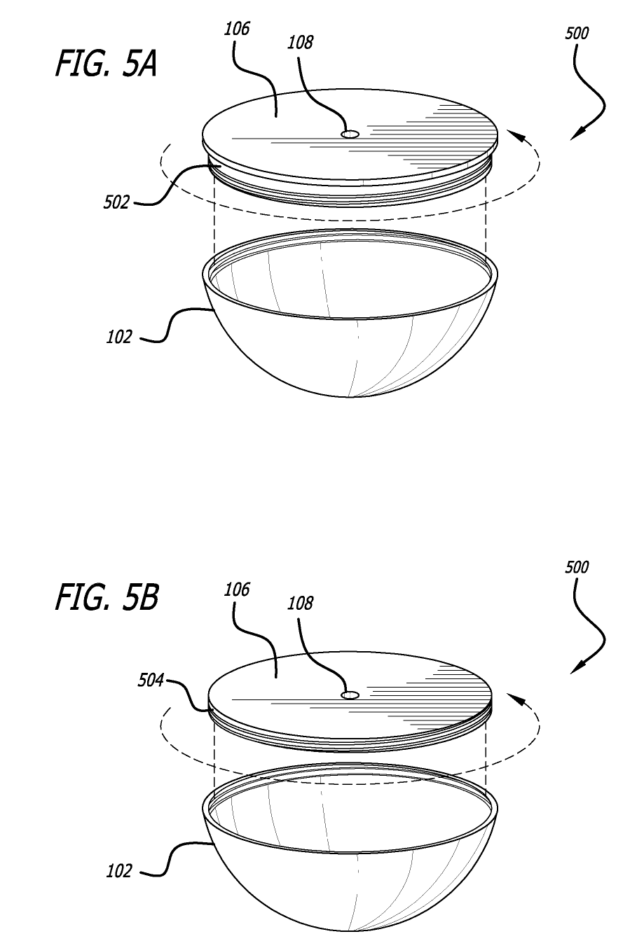

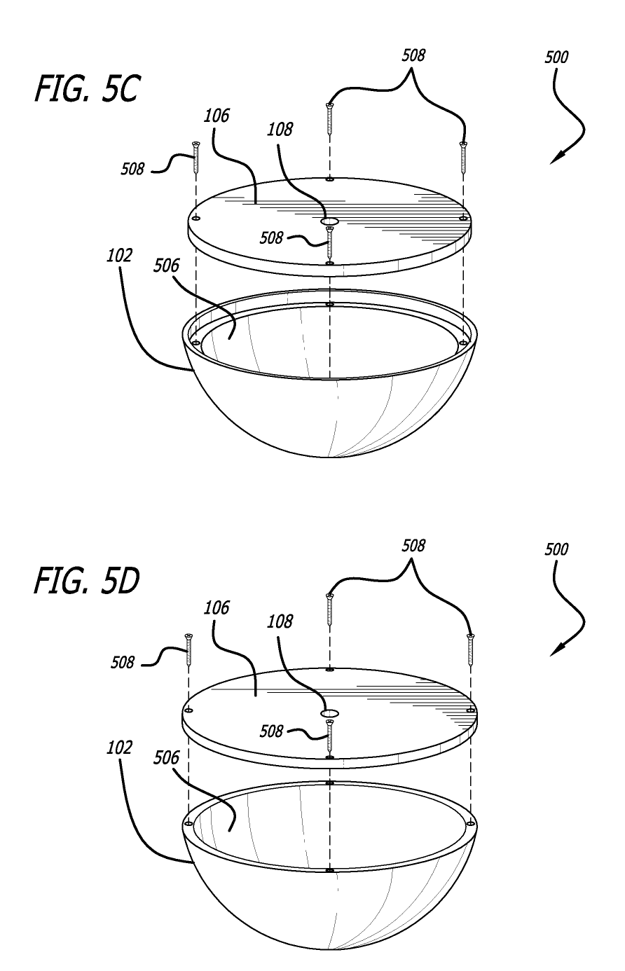

FIGS. 5A-5D illustrate various configurations for operably connecting the base cover 106 to the base 102. In particular, FIG. 5A illustrates the base cover 106 having a downwardly extending recessed portion 502, which may be threaded. The threads may matingly engage with internal threads located within the upward periphery of the base 102. In this configuration, a user can take hold of the outer portion of the base cover 106 to twist the base cover 106 on or off.

FIG. 5B illustrates the base cover 106 having a downwardly extending portion 504, which may be threaded. The threads may matingly engage with internal threads located within the upward periphery of the base 102. In this configuration, a user can take hold of the opening of the base cover 106 with his or her thumb or fingers to twist the base cover 106 on or off.

FIG. 5C illustrates the base cover 106 having a plurality of holes and the base 102 having an inner wall portion 506 with corresponding holes. A plurality of fasteners 508, such as screws, may then be inserted through the holes in the base cover 106 and the holes in the inner wall portion 506 to operably connect the base cover 106 to the base 102. The fasteners 508 are not limited to screws. For example, the fasteners 508 may also be bolts or the like.

FIG. 5D illustrates the base cover 106 having a plurality of holes and the top of the base 102 having corresponding holes. A plurality of fasteners 508, such as screws, may then be inserted through the holes in the based cover and the holes in the inner wall portion 506 to operably connect the base cover 106 to the base 102.

In another alternative embodiment, the top portion of the base cover 106 may have a flap that extends over the base 102. The flap may matingly engage the top portion of the base 102. The user may then simply pull the base cover 106 off of the base 102 and put it right back on by pressing down on the base cover 106 with respect to the base 102.

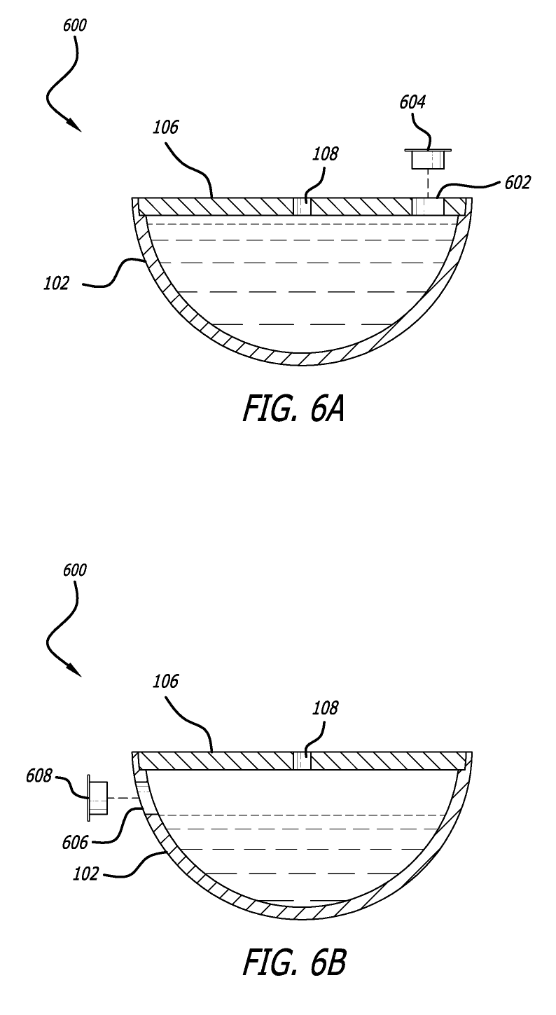

FIGS. 6A and 6B illustrate alternative configurations for filling and removing the compound from the compartment in the base 102. In particular, FIG. 6A illustrates an opening 602 in the base cover 106 in which the compound may be placed within the compartment or removed from the compartment of the base 102. For example, a fluid such as water may be poured into the compartment through the opening 602 or removed from the compartment through the opening 602. Further, a cap 604 may be utilized to cover the opening 602 to keep the fluid in the compartment of the base 102. The opening 602 and cap 604 configuration is particularly helpful in that a user does not have to remove the base cover 106 from the base 102 to fill the base 102 with fluid. Further, in one embodiment the base cover 106 is integrally connected to the base 102 such that the base cover 106 and the base 102 are a single piece. In such a configuration, the base cover 106 cannot be removed from the base 102, and the opening 602 and cap 604 configuration allows the user to fill, empty, and/or refill the base 102 with fluid or other compound such as sand.

The user's ability to empty the base 102 may be particularly useful for moving the dynamic microphone support apparatus 100. For instance, the user may want to travel with the dynamic microphone support apparatus 100. Accordingly, the user can empty compound, e.g., water, from the base 102 by removing the cap 604 and pouring the water out from the opening 602. Upon arriving at the intended destination, the user can then remove the cap 604, refill the base 102 with water, and place the cap 604 over the opening 602. As a result, the user can travel much more conveniently with a lighter dynamic microphone support apparatus 100.

FIG. 6B illustrates an opening 606 in the base 102 in which the compound may be placed within the compartment or removed from the compartment of the base 102. A cap 608 may be utilized to cover the opening 606. This opening 606 and cap 608 configuration operates similarly to the opening 602 and cap 604 configuration of FIG. 6A except that this particular configuration is along the side of the base 102. In an alternative embodiment, the opening 606 and cap 608 configuration may be positioned on the bottom of the base 102 to conceal the cap 608 from view.

In an alternative embodiment, the principles discussed above may be utilized with a base cover 106 that extends substantially outside of the periphery of the base 102. The base cover 106 may still be matingly engaged to the base 102 as discussed above, e.g., holes in the area of the base cover 106 directly above the holes in the base 102 so that screws may be inserted. The base cover 106 may extend sufficiently beyond the periphery of the base 102 to restrict the tilt of the base 102. The longer the extension of the base cover 106, the more restricted the tilt will be as the base cover 106 will contact the ground sooner and restrict movement. In an embodiment that provides for automatic movement back from the tilted position, springs may be positioned on the bottom of the extending base cover 106 to automatically push the base cover 106, and thereby the base 102 operably connected to the base cover 106, back from the tilt. In this embodiment, less emphasis on factors such as the angles and/or weight distribution of the compound are necessary.

It is understood that apparatus described herein may also be applied in other types of contexts. In other words, the dynamic microphone support apparatus 100 is not intended to be limited to use with a microphone 114. For example, the dynamic microphone support apparatus 100 may be utilized with an umbrella. A user may take the dynamic microphone support apparatus 100 to the beach and connect an umbrella to provide shade. Utilizing one of the configurations in FIGS. 6A and 6B, the user may even fill the dynamic microphone support apparatus 100 with water or sand once arriving at the beach so that carrying the dynamic microphone support apparatus 100 to the beach may be accomplished with relative ease. The dynamic microphone support apparatus 100 may provide the user with the ability to make small adjustments to the umbrella to provide shade for varying angles of sunlight. Various other components may also be connected to the dynamic microphone support apparatus 100. Those skilled in the art will appreciate that the various adaptations and modifications of the embodiments of this apparatus may be configured without departing from the scope and spirit of the present apparatus. Therefore, it is to be understood that, within the scope of the appended claims, the present apparatus may be practiced other than as specifically described herein.

I claim:

1. An apparatus comprising:
a base having a concave-shaped bottom portion that is positional on a surface;
a compartment in the base that stores an adhesive material;
a base cover that is positioned over the base and covers the compartment such that weight of a user positioned on the base cover applied in a direction causes the base to tilt with respect to the surface in the direction; and
a rod member having a first end, a second end, and a middle portion, the first end being positioned through an opening in the base cover into the adhesive material in the compartment such that the rod member is immovable with respect to the base, the second end configured to receive a microphone apparatus, and the middle portion configured to connect the first end and the second end.

2. The apparatus of claim 1, wherein the adhesive material is cement.

3. The apparatus of claim 1, wherein the adhesive material is glue.

5. The apparatus of claim 1, wherein the base cover is metal.

6. The apparatus of claim 1, wherein the base cover is plastic.

7. The apparatus of claim 1, wherein the microphone apparatus includes a microphone and a microphone connector, the microphone connector having a receptacle for the microphone and being configured to matingly engage with the second end.

8. The apparatus of claim 1, wherein the microphone apparatus includes a microphone that matingly engages with the second end.

9. The apparatus of claim 1, wherein the first end extends downward into the base and matingly engages an inner layer of the concave-shaped bottom portion.

10. The apparatus of claim 1, wherein the base cover matingly engages the base such that the base cover is immovable with respect to the base.

11. The apparatus of claim 1, wherein the base and the base cover are integrally formed from a same material.

12. The apparatus of claim 1, wherein an angle of curvature of the concave-shaped bottom portion of the base restricts the tilting of the base.

13. The apparatus of claim 12, wherein the angle of curvature of the concave-shaped bottom portion of the base causes the base to automatically move back to an original position of the base after the tilting of the base.

14. The apparatus of claim 1, wherein a weight distribution of the adhesive material directed towards the center of the base restricts the tilting of the base.

15. The apparatus of claim 14, wherein the weight distribution of the adhesive material directed towards the center of the base causes the base to automatically move back to an original position of the base after the tilting of the base.

16. An apparatus comprising:
a base having a concave-shaped bottom portion that is positional on a surface;
a compartment in the base that stores an adhesive material;
a base cover that is positioned over the base and covers the compartment such that weight of a user positioned on the base cover applied in a direction causes the base to tilt with respect to the surface in the direction; and
a rod member having a first end, a second end, and a middle portion, the first end being positioned through an opening in the base cover into the adhesive material in the compartment such that the rod member is immovable with respect to the base, the second end configured to receive a microphone apparatus, and the middle portion configured to connect the first end and the second end such that a force applied to the rod member in a direction by a user positioned on the base cover causes the base to tilt with respect to the surface in the direction.

17. The apparatus of claim 16, wherein an angle of curvature of the concave-shaped bottom portion of the base restricts the tilting of the base.

18. The apparatus of claim 17, wherein the angle of curvature of the concave-shaped bottom portion of the base causes the base to automatically move back to an original position of the base after the tilting of the base.

19. The apparatus of claim 16, wherein a weight distribution of the adhesive material directed towards the center of the base restricts the tilting of the base.

20. The apparatus of claim 19, wherein the weight distribution of the adhesive material directed towards the center of the base causes the base to automatically move back to an original position of the base after the tilting of the base.

21. An apparatus comprising:
a base having a concave-shaped bottom portion that is positional on a surface;
a compartment in the base that stores a compound to stabilize the weight of a user;
a base cover that is positioned over the base; and
a rod member having a first end, a second end, and a middle portion, the first end being connected to the base cover such that the rod member is immovable with respect to the base, the second end configured to receive a microphone apparatus, and the middle portion configured to connect the first end and the second end such that a force applied to the rod member in a direction by the user positioned on the base cover causes the compound to shift in the direction, which causes the base to tilt with respect to the surface in the direction.

22. The apparatus of claim 21, wherein the compound is water.

23. The apparatus of claim 21, wherein the compound is sand.

24. The apparatus of claim 21, wherein the compound is an adhesive material.

25. The apparatus of claim 21, wherein the base cover is metal.

26. The apparatus of claim 21, wherein the base cover is plastic.

27. The apparatus of claim 21, wherein the base cover includes a cap covering an opening to the compartment to access the compound.

28. The apparatus of claim 21, wherein the base includes a cap covering an opening to the compartment to access the compound.

29. The apparatus of claim 21, wherein an angle of curvature of the concave-shaped bottom portion of the base restricts the tilting of the base.

30. The apparatus of claim 29, wherein the angle of curvature of the concave-shaped bottom portion of the base causes the base to automatically move back to an original position of the base after the tilting of the base.

31. The apparatus of claim 21, wherein a weight distribution of the compound directed towards the center of the base restricts the tilting of the base.

32. The apparatus of claim 31, wherein the weight distribution of the compound directed towards the center of the base causes the base to automatically move back to an original position of the base after the tilting of the base.

33. A kit comprising:
a microphone stand apparatus that has (i) a base having a concave-shaped bottom portion that is positional on a surface, (ii) a compartment in the base that stores a compound to stabilize the weight of a user, (iii) a base cover that is positioned over the base, and (iv) a rod member having a first end, a second end, and a middle portion, the first end being connected to the base cover such that the rod member is immovable with respect to the base, the second end configured to receive a microphone apparatus, and the middle portion configured to connect the first end and the second end such that a force applied to the rod member in a direction by the user positioned on the base cover causes the compound to shift in the direction, which causes the base to tilt with respect to the surface in the direction; and
a microphone that is operably connected to the second end.

34. The kit of claim 33, wherein the microphone is operably connected to the second end via a microphone connector that has a receptacle for the microphone and matingly engages the second end.

35. The kit of claim 33, wherein the microphone is operably connected to the second end by being matingly engaged with the second end.
